(19) United States
(12) Patent Application Publication
(10) Pub. No.: US 2010/0269777 A1
(43) Pub. Date: Oct. 28, 2010

(54) INTAKE MANIFOLDS FOR INTERNAL COMBUSTION ENGINE

(76) Inventor: GENE JASPER, Huntington Beach, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/430,734

(22) Filed: Apr. 27, 2009

(51) Int. Cl. F02M 35/10

(52) U.S. Cl. 123/184.36; 123/184.55

(57) ABSTRACT

Improvements in an intake manifold for an internal combustion engine having separate plenum intake storage tanks. Each plenum stores an internal large volume of air that more easily drawn into intake conduits that feed air into the intake ports of an engine. Each plenum has one or more intake ports where air is supplied from a throttle body and a plurality of intake conduits. In the preferred embodiment there are three intake conduits that provide air for a total of six cylinders. The plenums are constructed from formed pieces to provide thinner walls thereby increasing the internal volume of the plenums. The plenums further have connection ports for sensors. The intake conduits terminate a distance within the plenum and have flared ends that can be oriented towards the center of the plenum to improve air movement and flow from the input.

### BACKGROUND OF THE INVENTION

1. Field of the Invention

This invention relates to improvements in an air intake manifold. More particularly the intake manifold is directed to an automobile air intake manifold that is configured to improve air flow into an automobile engine.

2. Description of Related Art including information disclosed under 37 CFR 1.97 and 1.98

An air intake manifold exists between the air filter and the head of an engine. This area is under a vacuum while the engine is in operation. The vacuum is caused by the pistons drawing in air. In general the faster the engine turns the greater amount of air passes through the intake manifold. The design and structure of the intake manifold has a significant effect on the performance of an engine. If the manifold has a restriction the volume of air is decreased. Obstructions and poor design of the manifold can cause turbulent air within the manifold and thereby decrease the efficiency of the engine. Several products and patents have been filed for air intake manifolds to optimize the air flow through the manifold. Exemplary examples of patents covering these products are disclosed herein.

U.S. Pat. No. 5,657,727 issued Aug. 19, 1997 to Masahiro Uchida discloses a V-Type Engine Induction System where the ends of the intake pipes are alternately placed within the plenum chamber. This patent provides a compact design where all of the intake tubes are approximately the same length. While this patent provides a number of intake pipes that all terminate within the plenum the design uses a single plenum and the plenum is not sufficiently sized to create a resonance chamber or a vacuum cavity that has sufficient volume to provide even pressure for all of the intake tubes.

U.S. Pat. No. 3,520,284 issued Jul. 14, 1970 to K. Ruoff et al discloses an Internal Combustion Engine Air Intake where the four intake tubes all receive air from a single synthetic distribution chamber. A single intake supplies air to the synthetic distribution chamber and each of the intake pipes begin within the synthetic distribution chamber. While this patent is related to the intake of a vehicle it does not supply air to a split plenum. The synthetic distribution chamber further does not provide a large volume vacuum chamber to provide equal air flow to all of the cylinders.

U.S. Pat. No. 2,382,244 issued Aug. 14, 1956 to W. G. Lundquist et al discloses an Intake Manifold arrangement where the intake pipes are bolted to the heads of the block and the intake pipes extend into the intake manifold chamber. While this patent provides intake pipes within a chamber, the pipes are each individually placed onto the block and there is only a single plenum chamber. This patent does not address a case where multiple chambers are needed wherein the pressure in each chamber should be essentially the same to allow the pistons to operate at a higher output level.

What is needed is an intake manifold for an internal combustion engine where two separate air chambers are used the two separate chambers must be sufficiently sized to provide an air vacuum reservoir so each cylinder brings in essentially the same volume of air to provide equal performance. A solution is provided in the pending application that uses a uniquely designed pair of air distribution manifolds.

### BRIEF SUMMARY OF THE INVENTION

It is an object of the intake manifold for an internal combustion engine to have multiple tuned resonance chambers. This provides a pair of pressure equalization tanks with sufficient volume so the volume of air that is being supplied to each cylinder is essentially the same thereby providing improved performance. The shape of the tanks provides optimal volume while they are configured to fit around existing engine components.

It is an object of the intake manifold for an internal combustion engine to use cylinder feeder tubes that have flared ends. The flared ends reduce turbulent air flow into each tube and provide a funnel for the air to enter into each tube.

It is an object of the intake manifold for an internal combustion engine for the plenum chamber to be constructed from an assembly of parts as opposed to being cast. The assembly allows for custom tuning and placement of the various components wherein casting provides for a fairly fixed arrangement of components, sizes and shapes.

It is an object of the intake manifold for an internal combustion engine for the assembly of the parts to be assembled, welded and tested with a series of annealing, welding and heat treating processes. Because physical placement of the parts is critical and the heating, welding, cooling and hardening of the parts can cause movement of the numerous pieces the location of the parts must be controlled through the production process.

It is another object of the intake manifold for an internal combustion engine for each of the separate ducting tubes to have lengths that are specifically designed to provide optimal air flow and volume. The optimal design provides at least the volume that will be drawn into a cylinder with each stroke. This ensures that sufficient volume is in close proximity to the cylinder intake valve.

It is still another object of the intake manifold for an internal combustion engine for the ends of the ducting tubes to be tipped or oriented into the resonance chamber this reduces air flow direction changes thereby providing a more linear flow from the intake port of the plenum through the ducting ports.

It is still another object of the intake manifold for an internal combustion engine for the diameter of the ducting tubes to provide maximum air flow to minimize flow restriction through the tubes. The tubes many further have different or tapered diameters to provide consistent air flow into each cylinder to provide consistent power from all cylinders.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of a prior art motor with prior art plenums.

FIG. 2 shows a detailed perspective view of the prior art plenums from FIG. 1.

FIG. 3 shows a perspective view of the preferred embodiment of improved air plenums with stock prior art throttle body.

FIG. 4 shows a first perspective view of the first of two air plenums.

FIG. 5 shows a second perspective view of the first of two air plenums.

FIG. 6 shows a first perspective view of the second of two air plenums.

FIG. 7 shows a second perspective view of the second of two air plenums.

FIG. 8 shows a side cross sectional view of an air plenum.

FIG. 9 shows a top cross sectional view of an air plenum.

### DETAILED DESCRIPTION OF THE INVENTION

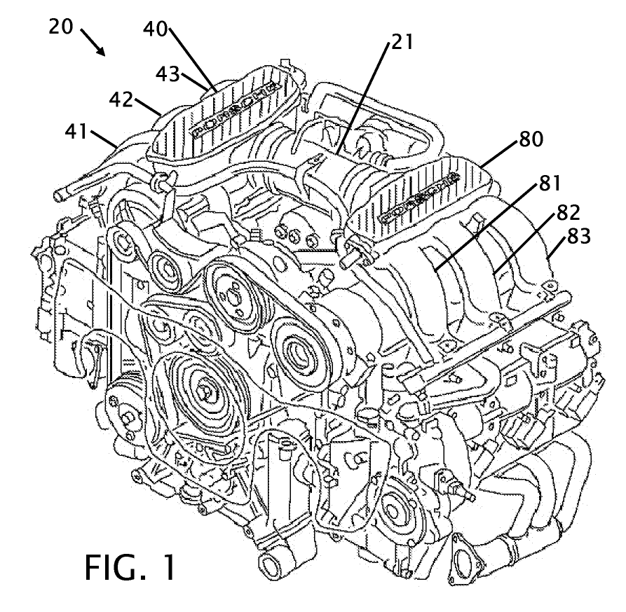

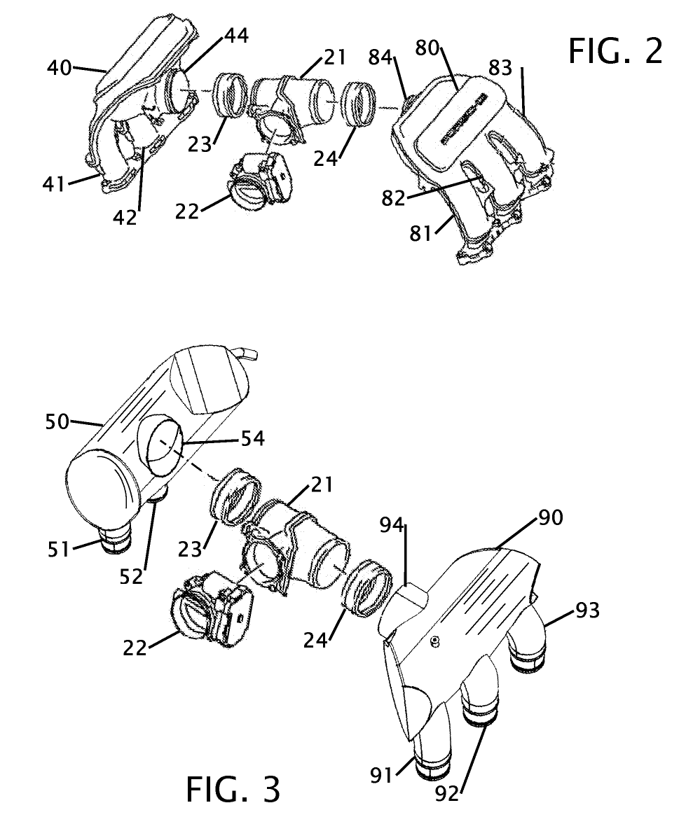

FIG. 1 shows a perspective view of a prior art motor with prior art plenums. This figure shows a typical configuration of an engine 20 with the plenum components. This figure is a stock Porsche engine 20. The air is brought into the engine from an air filter (not shown) where it is regulated through a throttle body (shown in FIG. 2). The throttle body is connected to a plenum T 21. The plenum T 21 diverts air from a single throttle body into two separate directions where the air flow then enters into a left plenum 40 and a right plenum 80. These prior art plenums have minimal internal volume and just split the air from a single input port to three intake conduits that are shown as items 41, 42 and 43 for the left stock plenum 40, and as items 81, 82 and 83 for the right stock plenum. The stock plenums are fabricated with a casting process. The stock air flow components are shown removed from the engine in FIG. 2 where they are more easily compared to the improved plenum design.

FIG. 2 shows a detailed perspective view of the prior art plenums from FIG. 1. In this figure the left stock plenum 40 and the right sock plenum 80 are not obscured by the other engine components. The throttle body 22 is visible. The throttle body regulates the amount of air that is drawn into the cylinders by opening and closing a port within the throttle body. The throttle body is screwed bolted or otherwise secured to the plenum T 21. Flexible couplings 23 and 24 connect the plenum T to the intake ports 44 and 84 of the plenums 40 and 80. Intake conduits 41, 42, 81, 82 and 83 connect from the body of the plenums 40 and 80. A brief observation of the plenum bodies 40 and 80 in FIG. 2 with the plenum bodies 50 and 90 is FIG. 3 show a significant difference to the volume of air or vacuum between the stock and the improved design. Referring now to the improvements that are shown in the additional accompanying figures that include the throttle body 22 and the T plenum 21 from FIG. 2.

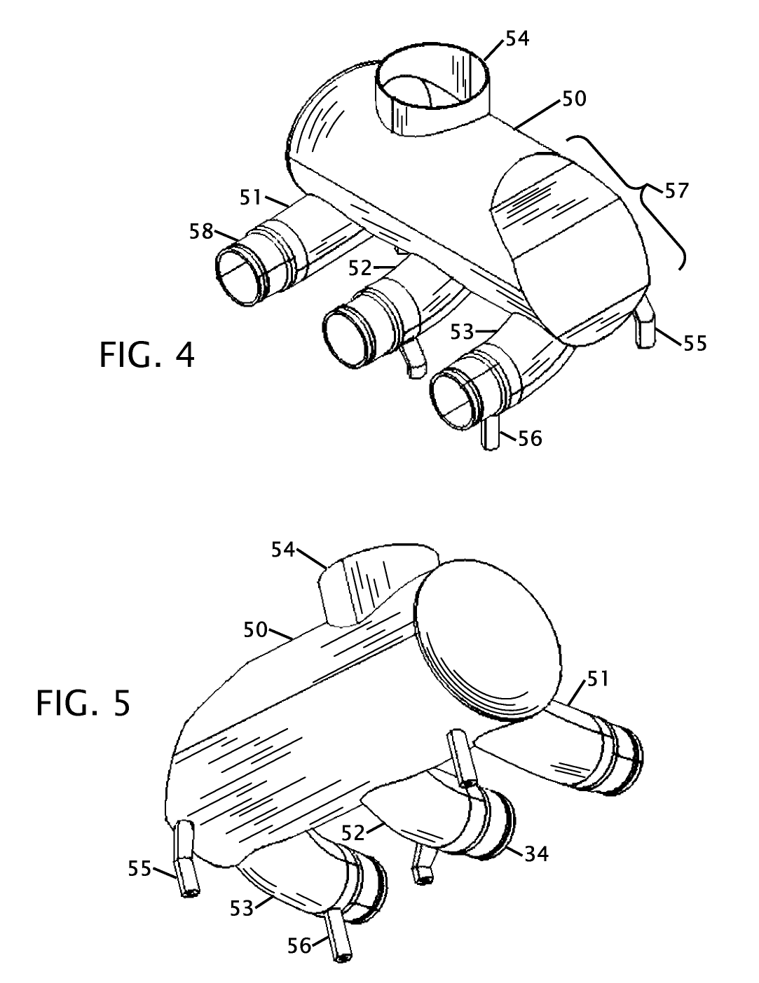

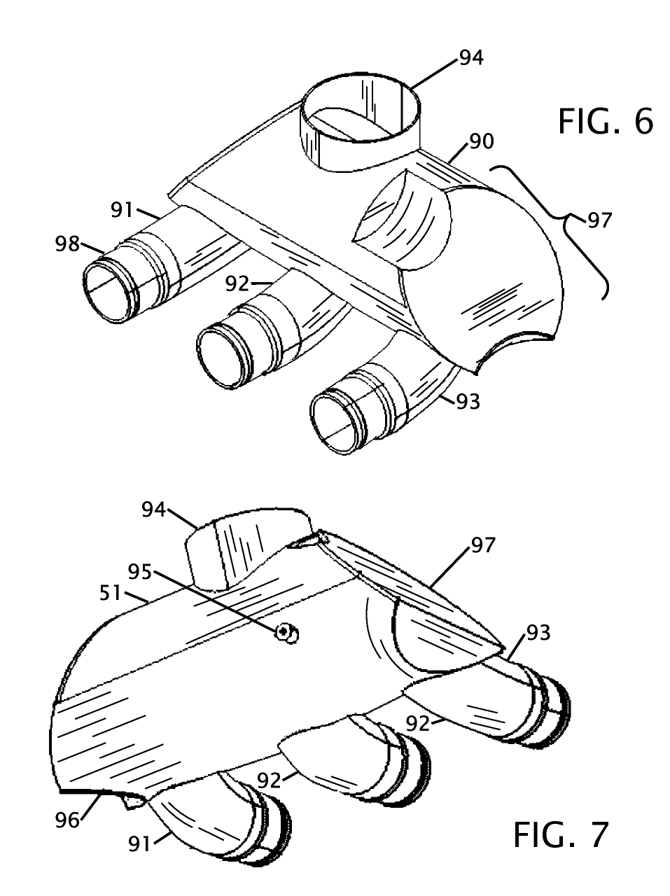

FIG. 3 shows a perspective view of the preferred embodiment of improved air plenums with stock prior art throttle body. In this preferred embodiment the throttle body 22 still connects to the T plenum 21. Flexible couplings 23 and 24 connect from the T plenum 21 to the improved left and right plenum chambers 50 and 90 respectively. Detailed views of the left 50 and right 90 plenums are shown and described in more detail where the left plenum 50 is shown in FIGS. 4 and 5 and the right plenum 90 is shown in FIGS. 6 and 7. The left plenum has an intake port 54 and three intake conduits (only two being shown) 51 and 52. The right plenum has an intake port 94 and three intake conduits 91, 92 and 92.

FIG. 4 and FIG. 5 shows perspective views of the first of two air plenums. Each plenum includes at least one intake port 54. It is contemplated that some embodiments may have more than one intake port 54. The intake port 54 is configured for connection of a flexible coupling to connect the intake port 54 to the T plenum shown in FIGS. 2 and 3. The additional intake ports may be used to increase the storage volume and to equalize the pressure (vacuum) between the two plenums. The internal volume of the plenum 51 is configured to tune the air flow within the plenum and improve performance of the engine. Both of the plenums are configured with essentially the same internal volume to maximize air at the closest proximity to the cylinders of an engine. The plenum chamber 50 has a plurality of intake conduits 51, 52 and 53 that supply a plurality of cylinders. In the preferred embodiment the each plenum has three intake conduits 51, 52 and 53 that feed each of three cylinders located on opposite side of the engine. The intake conduits 51, 52 and 53 are configured for connection with flexible hoses and have details 58 for connection using hose clamps. In the preferred embodiment this configuration is designed for use on a Porsche engine.

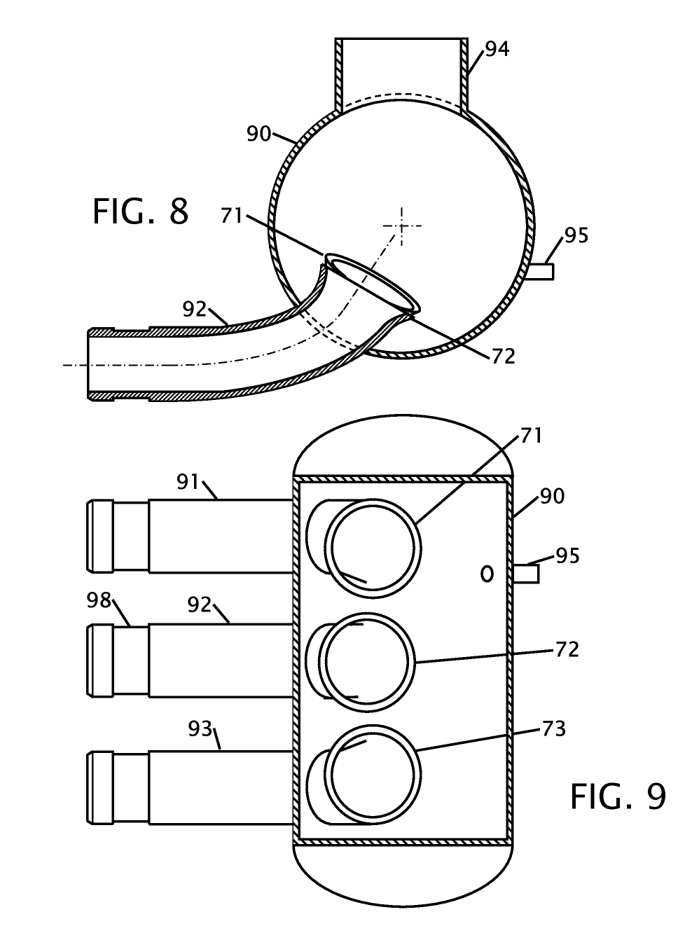

Each of the intake conduits terminate within the plenum or vacuum tank reservoir 51 with flared ends that open at a location distal from the wall of said tuned vacuum tank reservoir. The flared ends are shown and described in more detail in FIGS. 8 and 9. In the preferred embodiment the plenum tank assembly is a welded assembly from individual pieces. The plenum tank is preferably made from aluminum, but other materials are contemplated such as other metals or plastics that would provide equivalent or superior performance. The aluminum components are annealed and heat treated to maintain acceptable tolerance and shape. The interior of the aluminum surface is polished or pre-polished to improve air flow.

The tank 50 is essentially round in cross sectional configuration to achieve the greatest volume without creating dead air flow zones within the chamber 50. Depending upon the engine performance requirements the plenum may include one or more ports for the connection of a sensor 55. One or both of the plenums may include a connection for a vacuum line 56. It should be apparent from these figures that the intake port 54 and said intake conduits 51, 52 and 53 are essentially perpendicular and have essentially round cross sections. The sides of the tank 50 are configured with sculptures sides 57 or details that allow the tank 50 to fit within and around engine and engine compartment features, details and components.

FIG. 6 and FIG. 7 shows perspective views of the second of two air plenums. Each plenum includes at least one intake port 94. It is contemplated that some embodiments may have more than one intake port 94. The intake port 94 is configured for connection of a flexible coupling to connect the intake port 94 to the T plenum shown in FIGS. 2 and 3. The additional intake ports may be used to increase the storage volume and to equalize the pressure (vacuum) between the two plenums. The internal volume of the plenum 91 is configured to tune the air flow within the plenum and improve performance of the engine. Both of the plenums are configured with essentially the same internal volume to maximize air at the closest proximity to the cylinders of an engine. The plenum chamber 90 has a plurality of intake conduits 91, 92 and 93 that supply a plurality of cylinders. In the preferred embodiment the each plenum has three intake conduits 91, 92 and 93 that feed each of three cylinders located on opposite side of the engine. The intake conduits 91, 92 and 93 are configured for connection with flexible hoses and have details 98 for connection using hose clamps. In the preferred embodiment this configuration is designed for use on a Porsche engine.

Each of the intake conduits terminate within the plenum or vacuum tank reservoir 91 with flared ends that open at a location distal from the wall of said tuned vacuum tank reservoir. The flared ends are shown and described in more detail in FIGS. 8 and 9. In the preferred embodiment the plenum tank assembly is a welded assembly from individual pieces. The plenum tank is preferably made from aluminum, but other materials are contemplated such as other metals or plastics that would provide equivalent or superior performance. The aluminum components are annealed and heat treated to maintain acceptable tolerance and shape. The interior of the aluminum surface is polished or pre-polished to improve air flow.

The tank 90 is essentially round in cross sectional configuration to achieve the greatest volume without creating dead air flow zones within the chamber or tank 90. Depending upon the engine performance requirements the plenum may include one or more ports for the connection of a sensor 95. It should be apparent from these figures that the intake port 94 and said intake conduits 91, 92 and 93 are essentially perpendicular and have essentially round cross sections. The sides of the tank 90 are configured with sculptures sides 97 or clearance details 96 that allow the tank 90 to fit within and around engine and engine compartment features, details and components.

FIG. 8 shows a side cross sectional view of an air plenum. Just the plenum from FIGS. 6 and 7 is shown in this cross sectional view. The cross sectional configuration of the plenum shown in FIGS. 4 and 5 is basically the same. The plenum tank 90 is essentially round in cross section. The intake port 94 is show extending from the top of the plenum tank 90. A sensor port 95 is shown extending out the back of the plenum tank 90. While the sensor port 95 is shown at a particular location, position or side the location can be at any location on the plenum tank 90 (or 50). The intake conduit 92 is shown extending into the plenum tank 90 where it terminates at a depth within the plenum tank 90 with a flared opening 72. The flared opening 71 from and adjacent intake conduit is shown in this figure at a different depth within the plenum tank and at an angle that tips the intake conduit towards the center of the plenum tank 90.

FIG. 9 shows a top cross sectional view of an air plenum. Just the plenum from FIGS. 6 and 7 is shown in this cross sectional view. The cross sectional configuration of the plenum shown in FIGS. 4 and 5 is basically the same. Each of the three intake conduits 91, 92 and 93 are shown entering the plenum tank 90. The central flared tube 72 sits essentially in the center of the tank, while the side flared tube 71 and 73 are tipped slightly towards the center of the plenum tank 90. The intake conduits 91, 92 and 93 are configured for connection with flexible hoses and have details 98 for connection using hose clamps. A sensor port 95 is visible on the back of the plenum tank 90.

Thus, specific embodiments of an intake manifold for an internal combustion engine have been disclosed. It should be apparent, however, to those skilled in the art that many more modifications besides those described are possible without departing from the inventive concepts herein. The inventive subject matter, therefore, is not to be restricted except in the spirit of the appended claims.

1. A two chamber tuned plenum tank for a motor vehicle comprising:
a pair of separate plenums that receive air from a single throttle body;
each plenum includes at least one intake port;
a tuned vacuum tank reservoir that is sufficiently sized to provide essentially equal vacuum to a plurality of intake conduits that supply a plurality of cylinders;
each of said intake conduits terminate within said tuned vacuum tank reservoirs with flared ends that open at a location distal from the wall of said tuned vacuum tank reservoir.

2. The two chamber tuned plenum tank for a motor vehicle according to claim 1 wherein at least two of each of said intake conduits extend within said plenum tank different depths.

3. The two chamber tuned plenum tank for a motor vehicle according to claim 1 wherein said two chamber tuned plenum tank is a welded assembly from individual pieces.

4. The two chamber tuned plenum tank for a motor vehicle according to claim 3 wherein said two chamber tuned plenum tank is made from aluminum.

5. The two chamber tuned plenum tank for a motor vehicle according to claim 4 wherein said two chamber tuned plenum tank is annealed and heat treated.

6. The two chamber tuned plenum tank for a motor vehicle according to claim 1 wherein at least one of said intake conduits is angled inward within said plenum tank.

7. The two chamber tuned plenum tank for a motor vehicle according to claim 1 wherein each of said two chamber tuned plenum tanks includes three intake conduits.

8. The two chamber tuned plenum tank for a motor vehicle according to claim 1 wherein each of said tuned plenum tanks is essentially round in cross section.

9. The two chamber tuned plenum tank for a motor vehicle according to claim 1 that further includes at least one port for the connection of a sensor.

10. The two chamber tuned plenum tank for a motor vehicle according to claim 1 wherein ends of said intake conduits are configured for connection with at least one flexible hose.

11. The two chamber tuned plenum tank for a motor vehicle according to claim 1 wherein each of said intake ports are configured for connection with a flexible hose.

12. The two chamber tuned plenum tank for a motor vehicle according to claim 1 wherein a volume of each of said two chambers is essentially the same.

13. The two chamber tuned plenum tank for a motor vehicle according to claim 1 wherein said intake port and said intake conduits are essentially perpendicular.

14. The two chamber tuned plenum tank for a motor vehicle according to claim 1 wherein said two chamber tuned plenum tanks are configured for use with a Porsche.

15. The two chamber tuned plenum tank for a motor vehicle according to claim 1 wherein said intake ports are round in cross section.

16. The two chamber tuned plenum tank for a motor vehicle according to claim 1 wherein said intake conduits are round in cross section.

17. The two chamber tuned plenum tank for a motor vehicle according to claim 1 wherein the sides of each of said plenum tank(s) are configured to accommodate components placed around an engine and an engine compartment.

18. The two chamber tuned plenum tank for a motor vehicle according to claim 1 further includes at least one port for the connection of a vacuum line.

19. The two chamber tuned plenum tank for a motor vehicle according to claim 1 wherein end of said intake conduits have recesses for hose clamps.

20. The two chamber tuned plenum tank for a motor vehicle according to claim 1 wherein the internal surface of said plenum, said intake port and said intake conduits are polished.
